(19) United States
(12) Patent Application Publication
(10) Pub. No.: US 2007/0240511 A1
(43) Pub. Date: Oct. 18, 2007

(54) Angular rate sensor and method of manufacturing the same

(75) Inventors: Takamitsu Higuchi, Matsumoto (JP); Makoto Eguchi, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/784,659

(22) Filed: Apr. 9, 2007

(30) Foreign Application Priority Data
Apr. 17, 2006 (JP) 2006-113491

(51) Int. Cl. G01P 15/09

(52) U.S. Cl. 73/514.34

(57) ABSTRACT

An angular rate sensor including: a silicon-on-insulator (SOI) substrate having a substrate, an oxide layer formed above the substrate, and a semiconductor layer formed above the oxide layer; a tuning-fork type vibrating portion obtained by processing the semiconductor layer and the oxide layer and formed of the semiconductor layer; a driving portion which generates flexural vibration of the vibrating portion; and a detecting portion which detects an angular rate applied to the vibrating portion. The vibrating portion has a supporting portion and two beam portions formed in a shape of cantilevers supported by the supporting portion; a pair of the driving portions is formed above each of the two beam portions, each of the driving portions having a first electrode layer, a piezoelectric layer formed above the first electrode layer, and a second electrode layer formed above the piezoelectric layer; and the detecting portion is formed above each of the two beam portions, the detecting portion being disposed between the pair of driving portions and having a first electrode layer, a piezoelectric layer formed above the first electrode layer, and a second electrode layer formed above the piezoelectric layer.

Japanese Patent Application No. 2006-113491, filed on Apr. 17, 2006, is hereby incorporated by reference in its entirety.

### BACKGROUND OF THE INVENTION

The present invention relates to an angular rate sensor in which a tuning-fork type vibrating portion formed on an SOI substrate is driven by vibration of a piezoelectric layer.

Information instruments such as digital cameras, digital video cameras, mobile phones, and car navigation systems carry an acceleration sensor and an angular rate sensor in order to prevent blurring of images due to hand movement or to detect the position of a vehicle. An angular rate sensor has been widely employed which detects the Coriolis force by piezoelectric effects. A reduction in size and power consumption of a sensor module has been demanded along with an increase in complexity of the module and a reduction in the size of instruments. As the oscillator used for the angular rate sensor module, a 32 kHz tuning-fork oscillator is still used to utilize the existing design and energy saving properties. The tuning-fork oscillator has a structure in which a piezoelectric such as a crystal formed in the shape of a tuning fork is sandwiched between electrodes so that the piezoelectric can be driven. The tuning-fork oscillator has advantages such as excellent temperature properties and energy saving properties. However, when forming a 32 kHz band tuning-fork oscillator, the length of the prong of the tuning fork becomes as large as several millimeters, whereby the entire length including the package becomes as large as almost 10 mm.

In recent years, angular rate sensors have been developed utilizing an oscillator using a piezoelectric thin film formed on a silicon substrate instead of a crystal. Such an oscillator has a stacked structure provided on a silicon substrate and formed by placing a piezoelectric thin film between upper and lower electrodes, and generates flexural vibration by in-plane extraction-contraction movement. Known structures of such an oscillator are a beam structure (FIG. 1 of JP-A-2005-291858) and a structure having a tuning-fork oscillator formed of two beams (FIG. 1 of JP-A-2005-249395).

When utilizing the oscillator using the piezoelectric thin film formed on the silicon substrate, since the thickness of a silicon substrate can only be reduced to about 100 micrometers, the sound velocity of flexural vibration can only be reduced to about several hundreds of meters per second. In order to obtain a resonance frequency in a band of several tens of kilohertz, the length of the beam needs to be increased to several millimeters or more. This makes it difficult to reduce the size of the angular rate sensor module.

### SUMMARY

According to a first aspect of the invention, there is provided an angular rate sensor comprising:

a silicon-on-insulator (SOI) substrate having a substrate, an oxide layer formed above the substrate, and a semiconductor layer formed above the oxide layer;

a tuning-fork type vibrating portion obtained by processing the semiconductor layer and the oxide layer and formed of the semiconductor layer;

a driving portion which generates flexural vibration of the vibrating portion; and

a detecting portion which detects an angular rate applied to the vibrating portion,

the vibrating portion having a supporting portion and two beam portions formed in a shape of cantilevers supported by the supporting portion;

a pair of the driving portions being formed above each of the two beam portions, each of the driving portions having a first electrode layer, a piezoelectric layer formed above the first electrode layer, and a second electrode layer formed above the piezoelectric layer; and

the detecting portion being formed above each of the two beam portions, the detecting portion being disposed between the pair of driving portions and having a first electrode layer, a piezoelectric layer formed above the first electrode layer, and a second electrode layer formed above the piezoelectric layer.

According to a second aspect of the invention, there is provided a method of manufacturing an angular rate sensor comprising:

providing a silicon-on-insulator (SOI) substrate having a substrate, an oxide layer formed above the substrate, and a semiconductor layer formed above the oxide layer;

forming a driving portion and a detecting portion by sequentially forming a first electrode layer, a piezoelectric layer, and a second electrode layer having a specific pattern above the SOI substrate;

patterning the semiconductor layer to form a vibrating portion; and

patterning the oxide layer to form an opening portion below the vibrating portion,

the vibrating portion being formed to have a supporting portion and two beam portions formed in a shape of cantilevers supported by the supporting portion;

the driving portion being formed so that a pair of the driving portions is formed above each of the two beam portions and each of the driving portions has a first electrode layer, a piezoelectric layer formed above the first electrode layer, and a second electrode layer formed above the piezoelectric layer; and

the detecting portion being formed so that the detecting portion is disposed above each of the two beam portions and between the pair of driving portions and has a first electrode layer, a piezoelectric layer formed above the first electrode layer, and a second electrode layer formed above the piezoelectric layer.

### BRIEF DESCRIPTION OF THE SEVERAL VIEWS OF THE DRAWING

FIG. 1 is a plan view schematically showing the structure of an angular rate sensor according to one embodiment of the invention.

FIG. 2 is a cross-sectional view of the angular rate sensor shown in FIG. 1 taken along the line A-A.

FIG. 3 is a cross-sectional view of the angular rate sensor shown in FIG. 1 taken along the line B-B.

FIG. 4 is a cross-sectional view schematically showing a method of manufacturing an angular rate sensor according to one embodiment of the invention.

FIG. 5 is a cross-sectional view schematically showing the method of manufacturing an angular rate sensor according to one embodiment of the invention.

FIG. 6 is a cross-sectional view schematically showing the method of manufacturing an angular rate sensor according to one embodiment of the invention.

### DETAILED DESCRIPTION OF THE EMBODIMENT

The invention may provide an extremely small angular rate sensor having a tuning-fork oscillator which can be driven at a frequency in a band of several tens of kilohertz, for example.

According to one embodiment of the invention, there is provided an angular rate sensor comprising:

a silicon-on-insulator (SOI) substrate having a substrate, an oxide layer formed above the substrate, and a semiconductor layer formed above the oxide layer;

a tuning-fork type vibrating portion obtained by processing the semiconductor layer and the oxide layer and formed of the semiconductor layer;

a driving portion which generates flexural vibration of the vibrating portion; and

a detecting portion which detects an angular rate applied to the vibrating portion,

the vibrating portion having a supporting portion and two beam portions formed in a shape of cantilevers supported by the supporting portion;

a pair of the driving portions being formed above each of the two beam portions, each of the driving portions having a first electrode layer, a piezoelectric layer formed above the first electrode layer, and a second electrode layer formed above the piezoelectric layer; and

the detecting portion being formed above each of the two beam portions, the detecting portion being disposed between the pair of driving portions and having a first electrode layer, a piezoelectric layer formed above the first electrode layer, and a second electrode layer formed above the piezoelectric layer.

In the angular rate sensor according to this embodiment, since the vibrating portion is formed of the semiconductor layer of the SOI substrate, the thickness of the vibrating portion and the length of the beam portion can be reduced. As a result, the angular rate sensor according to this embodiment is reduced in size and can measure angular rate by driving the vibrating portion at a desired resonance frequency, e.g., a low resonance frequency of several tens of kilohertz. In this embodiment, the vibrating portion may have a thickness of 20 micrometers or less and a length of 2 mm or less, for example.

In this embodiment, the vibrating portion may have a resonance frequency in a 32 kHz band. This is because the angular rate sensor exhibits increased sensitivity as the driving frequency is reduced, and the 32 kHz band frequency is a versatile oscillation frequency. The resonance frequency in the 32 kHz band may be in the range of 16 kHz to 66 kHz, for example. This is because a 32.768 kHz oscillator circuit can be driven at 16.384 kHz by adding a divider circuit, and a 32.768 kHz oscillator circuit can be driven at 65.536 kHz by adding a phase locked loop.

In this embodiment, the piezoelectric layer may be formed of lead zirconate titanate or a lead zirconate titanate solid solution.

According to one embodiment of the invention, there is provided a method of manufacturing an angular rate sensor comprising:

providing a silicon-on-insulator (SOI) substrate having a substrate, an oxide layer formed above the substrate, and a semiconductor layer formed above the oxide layer;

forming a driving portion and a detecting portion by sequentially forming a first electrode layer, a piezoelectric layer, and a second electrode layer having a specific pattern above the SOI substrate;

patterning the semiconductor layer to form a vibrating portion; and

patterning the oxide layer to form an opening portion below the vibrating portion,

the vibrating portion being formed to have a supporting portion and two beam portions formed in a shape of cantilevers supported by the supporting portion;

the driving portion being formed so that a pair of the driving portions is formed above each of the two beam portions and each of the driving portions has a first electrode layer, a piezoelectric layer formed above the first electrode layer, and a second electrode layer formed above the piezoelectric layer; and

the detecting portion being formed so that the detecting portion is disposed above each of the two beam portions and between the pair of driving portions and has a first electrode layer, a piezoelectric layer formed above the first electrode layer, and a second electrode layer formed above the piezoelectric layer.

The manufacturing method according to this embodiment allows an angular rate sensor to be easily manufactured by a known MEMS technology.

Next, one embodiment of the invention is described below with reference to the drawings.

1. Angular Rate Sensor

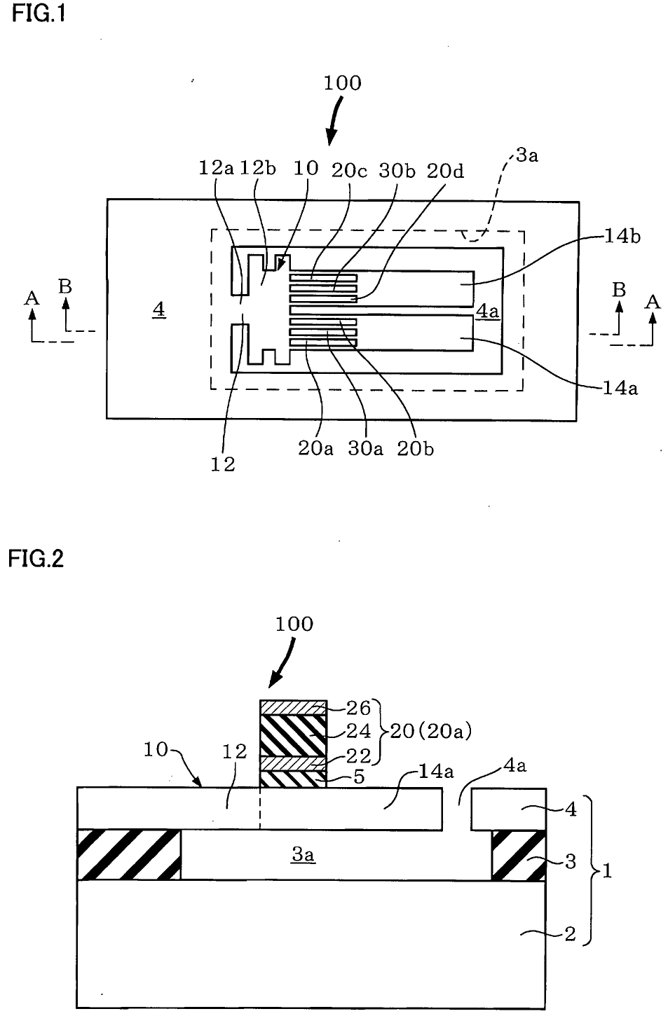

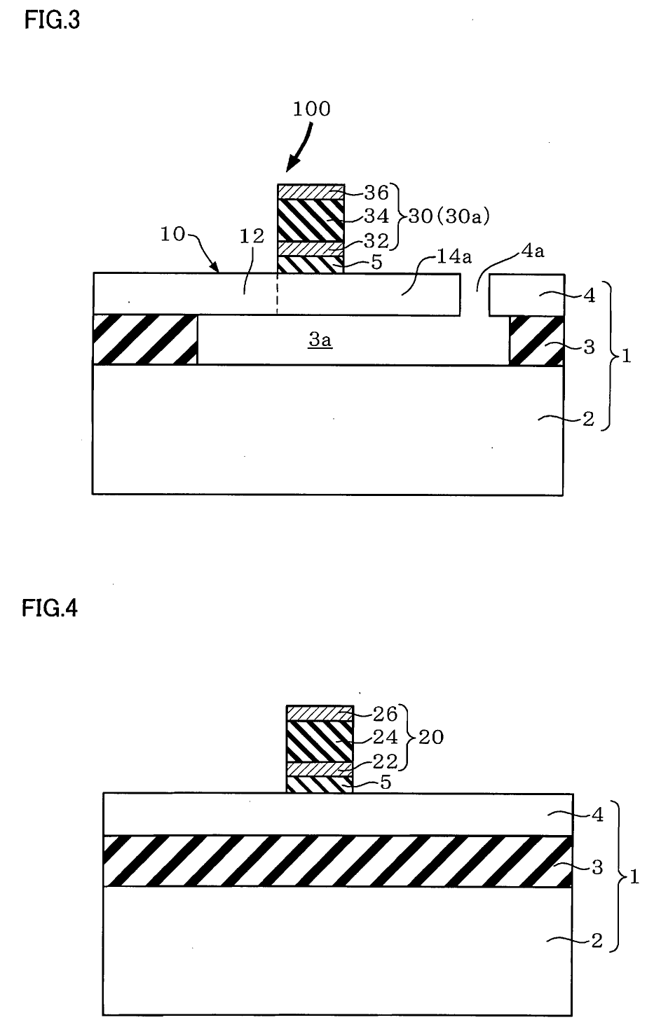

FIG. 1 is a plan view schematically showing the structure of an angular rate sensor 100 according to one embodiment of the invention, FIG. 2 is a cross-sectional view schematically showing the structure along the line A-A shown in FIG. 1, and FIG. 3 is a cross-sectional view schematically showing the structure along the line B-B shown in FIG. 1.

As shown in FIGS. 1 to 3, the angular rate sensor 100 includes an SOI substrate 1, a tuning-fork type vibrating portion 10 formed on the SOI substrate 1, a driving portion 20 (20a to 20d) for generating flexural vibration of the vibrating portion 10, and a detecting portion 30 (30a and 30b) for detecting the angular rate applied to the vibrating portion 10.

As shown in FIGS. 2 and 3, the SOI substrate 1 includes an oxide layer (silicon oxide layer) 3 and a silicon layer 4 stacked on a silicon substrate 2 in that order. The silicon layer 4 preferably has a thickness of 20 micrometers or less in order to reduce the size of the angular rate sensor 100. Since the SOI substrate 1 can also be used as a semiconductor substrate so that various semiconductor circuits can be formed on the SOI substrate 1, the angular rate sensor and a semiconductor integrated circuit can be integrally formed. It is advantageous to use a silicon substrate because a general semiconductor manufacturing technology can be utilized.

The vibrating portion 10 has a tuning-fork planar shape, as shown in FIG. 1, and is formed over an opening portion 3a formed by partially removing the oxide layer 3 of the SOI substrate 1, as shown in FIGS. 2 and 3. An opening 4a which allows vibration of the vibrating portion 10 is formed around the vibrating portion 10. The vibrating portion 10 includes a supporting portion 12 and two beam portions 14a and 14b formed in the shape of cantilevers supported by the supporting portion 12. The first beam portion 14a and the second beam portion 14b are disposed in parallel in the longitudinal direction at a predetermined interval.

The supporting portion 12 includes a first supporting portion 12a continuous with the silicon layer 4 and a second supporting portion 12b having a width larger than that of the first supporting portion 12a. The second supporting portion 12b has a function of supporting the first beam portion 14a and the second beam portion 14b and a function of preventing vibration of the beams 14a and 14b from propagating toward the supporting portion 12a. The side of the second supporting portion 12b may have a projection/depression to achieve such a function, as shown in FIG. 1.

As shown in FIG. 1, a pair of driving portions 20 is formed on each of the first beam portion 14a and the second beam portion 14b. That is, the first driving portion 20a and the second driving portion 20b are formed on the first beam portion 14a in parallel along the longitudinal direction of the first beam portion 14a. Likewise, the third driving portion 20c and the fourth driving portion 20d are formed on the second beam portion 14b in parallel along the longitudinal direction of the second beam portion 14b. The first driving portion 20a disposed on the outer side of the first beam portion 14a and the third driving portion 20c disposed on the outer side of the second beam portion 14b are electrically connected through a wire (not shown). The second driving portion 20b disposed on the inner side of the first beam portion 14a and the fourth driving portion 20d disposed on the inner side of the second beam portion 14b are electrically connected through a wire (not shown).

As shown in FIG. 2, the driving portion 20 (20a to 20d) includes a first electrode layer 22 formed on an underlayer 5, a piezoelectric layer 24 formed above the first electrode layer 22, and a second electrode layer 26 formed above the piezoelectric layer 24.

As shown in FIG. 1, one detecting portion 30 is formed on each of the first beam portion 14a and the second beam portion 14b. That is, the first detecting portion 30a is formed on the first beam portion 14a in parallel to the first and second driving portions 20a and 20b along the longitudinal direction of the first beam portion 14a. Likewise, the second driving portion 30b is formed on the second beam portion 14b in parallel to the third and fourth driving portions 20c and 20d in the longitudinal direction of the second beam portion 14b. The first detecting portion 30a is disposed between the first driving portion 20a and the second driving portion 20b. Likewise, the second driving portion 30b is disposed between the third driving portion 20c and the fourth driving portion 20d. The first detecting portion 30a and the second detecting portion 30b are connected with a detecting circuit (not shown) for detecting an angular rate signal.

As shown in FIG. 3, the detecting portion 30 (30a and 30b) includes a first electrode layer 32 formed on the underlayer 5, a piezoelectric layer 34 formed above the first electrode layer 32, and a second electrode layer 36 formed above the piezoelectric layer 34.

The underlayer 5 is an insulating film formed of a silicon oxide layer (SiO₂), a silicon nitride layer (Si₃N₄), or the like, and may include two or more layers. An arbitrary electrode material such as Pt may be used for the first electrode layers 22 and 32. The thicknesses of the first electrode layers 22 and 32 are not limited insofar as a sufficiently low electrical resistance is obtained. The thicknesses of the first electrode layers 22 and 32 may be 10 nm or more and 5 micrometers or less.

An arbitrary piezoelectric material such as lead zirconate titanate may be used for the piezoelectric layers 24 and 34. The piezoelectric layers 24 and 34 preferably have a thickness which is approximately 0.1 to 1 time the thickness of the silicon layer 4. This ensures a driving force for sufficiently vibrating the silicon layer forming the beam portions 14a and 14b. Therefore, when the silicon layer 4 has a thickness of 1 micrometer to 20 micrometers, the piezoelectric layers 24 and 34 may have a thickness of 100 nm or more and 20 micrometers or less.

An arbitrary electrode material such as Pt may be used for the second electrode layers 26 and 36. The thicknesses of the second electrode layers 26 and 36 are not limited insofar as a sufficiently low electrical resistance is obtained. The thicknesses of the second electrode layers 26 and 36 may be 10 nm or more and 20 micrometers or less.

In the driving portion 20 according to this embodiment, only the piezoelectric layer 24 is provided between the first electrode layer 22 and the second electrode layer 26. Note that the driving portion 20 may have a layer other than the piezoelectric layer 24 between the electrode layers 22 and 26. In the detecting portion 30, only the piezoelectric layer 34 is provided between the first electrode layer 32 and the second electrode layer 36. Note that the detecting portion 30 may have a layer other than the piezoelectric layer 34 between the electrode layers 32 and 36. In this case, the thicknesses of the piezoelectric layers 24 and 34 may be appropriately adjusted depending on the resonance conditions.

In this embodiment, when applying an alternating electric field to the first to fourth driving portions 20a to 20d, the first beam portion 14a and the second beam portion 14b symmetrically produce a flexural vibration (first flexural vibration), thereby realizing a tuning-fork vibration. A flexural vibration (second flexural vibration) occurs in the direction perpendicular to the first flexural vibration of the vibrating portion 10 due to the Coriolis force generated by the angular rate around the axis parallel to the center line between the first and second beam portions 14a and 14b. Therefore, the angular rate can be determined by detecting the voltage between the detecting portions 30a and 30b generated by the second flexural vibration using the detecting circuit.

Next, a configuration example of the angular rate sensor 100 according to this embodiment will be described.

(A) In the angular rate sensor 100 according to a first example, the first electrode layers 22 and 32 have a thickness of 0.1 micrometer, the piezoelectric layers 24 and 34 have a thickness of 2 micrometers, the second electrode layers 26 and 36 have a thickness of 0.1 micrometer, the driving portion 20 has a thickness of 2.2 micrometers, the silicon layer 4 has a thickness of 20 micrometers, and the beam portions 14a and 14b have a thickness of 1280 micrometers and a width of 40 micrometers. The vibrating portion 10 is positioned in the opening 4a of which the long side is 2000 micrometers and the short side is 100 micrometers. The flexural vibration resonance frequency of the angular rate sensor 100 having such a structure, obtained by simulation conducted by solving an equation of motion using a finite element method, was 32 kHz. The sensitivity obtained by simulation was 100 mV/deg/sec.

(B) In the angular rate sensor 100 according to a second example, the first electrode layers 22 and 32 have a thickness of 0.1 micrometer, the piezoelectric layers 24 and 34 have a thickness of 1 micrometer, the second electrode layers 26 and 36 have a thickness of 0.1 micrometer, the driving portion 20 has a thickness of 1.2 micrometers, the silicon layer 4 has a thickness of 2 micrometers, and the beam portions 14a and 14b have a thickness of 800 micrometers and a width of 4 micrometers. The vibrating portion 10 is positioned in the opening 4a of which the long side is 1000 micrometers and the short side is 10 micrometers. The flexural vibration resonance frequency of the angular rate sensor 100 having such a structure, obtained by simulation conducted by solving an equation of motion using a finite element method, was 32 kHz. The sensitivity obtained by simulation was 0.1 mV/deg/sec.

In the angular rate sensor 100 according to this embodiment, since the vibrating portion 10 is formed of the semiconductor layer 4 of the SOI substrate 1, the thickness of the vibrating portion 10 and the lengths of the beam portions 14a and 14b can be reduced. As a result, the angular rate sensor 100 according to this embodiment is reduced in size and can measure the angular rate by driving the vibrating portion 10 at a desired resonance frequency, e.g., a low resonance frequency of several tens of kilohertz. In this embodiment, the vibrating portion 10 may have a thickness of 20 micrometers or less and a length of 2 mm or less, for example. The angular rate sensor 100 according to this embodiment may be packaged to have a length of 3 mm or less when using a 32 kHz band frequency.

In the case of using the angular rate sensor 100 according to this embodiment for an angular rate sensor module, since the angular rate sensor 100 can be mounted on an electronic device having an SOI substrate in which semiconductor circuits are integrated, the size of the package can be significantly reduced.

According to this embodiment, since the angular rate sensor 100 can be formed on the SOI substrate 1, the oscillator circuit and the angular rate sensor can be integrally formed on the SOI substrate. As a result, a one-chip angular rate sensor module with significantly low power consumption can be realized by utilizing the low operating voltage of the device using the SOI substrate 1.

2. Method of Manufacturing Angular Rate Sensor

An example of a method of manufacturing the angular rate sensor 100 according to one embodiment of the invention will be described with reference to FIGS. 4 to 6. FIGS. 4 to 6 are cross-sectional views along the line A-A shown in FIG. 1.

(1) As shown in FIG. 4, the driving portion 20 and the detecting portion 30 are formed on the SOI substrate 1. Specifically, the underlayer 5, the first electrode layers 22 and 32, the piezoelectric layers 24 and 34, and the second electrode layers 26 and 36 respectively forming the driving portion 20 and the detecting portion 30 are formed in that order. The SOI substrate 1 includes the oxide layer (silicon oxide layer) 3 and the silicon layer 4 formed on the silicon substrate 2 in that order.

The underlayer 5 may be formed by a thermal oxidation method, a CVD method, a sputtering method, or the like. The underlayer 5 is formed in a desired shape by patterning. The patterning may be performed by an ordinary photolithography and etching technique.

The first electrode layers 22 and 32 may be formed on the underlayer 5 using a vapor deposition method, a sputtering method, or the like. The first electrode layers 22 and 32 are formed in a desired shape by patterning. The patterning may be performed by an ordinary photolithography and etching technique.

The piezoelectric layers 24 and 34 may be formed by various methods such as a deposition method, a sputtering method, a laser ablation method, and a CVD method. For example, when forming a lead zirconate titanate layer by a laser ablation method, a lead zirconate titanate target such as a Pb_{1.05}Zr_{0.52}Ti_{0.48}NbO₃ target, is irradiated with laser light. The lead atoms, zirconium atoms, titanium atoms, and oxygen atoms are released from the target by ablation to produce a plume due to laser energy, and the plume is applied to the SOI substrate. This allows the piezoelectric layers 24 and 34 to be formed of lead zirconate titanate on the first electrode layers 22 and 32. The piezoelectric layers 24 and 34 are formed in a desired shape by patterning. The patterning may be performed by an ordinary photolithography and etching technique.

The second electrode layers 26 and 36 may be formed by a deposition method, a sputtering method, a CVD method, or the like. The second electrode layers 26 and 36 are formed in a desired shape by patterning. The patterning may be performed by an ordinary photolithography and etching technique.

(2) As shown in FIG. 5, the silicon layer 4 of the SOI substrate 1 is patterned into a desired shape. Specifically, the vibrating portion 10 of a desired planar shape is formed in the opening 4a in the silicon layer 4, as shown in FIG. 1. The silicon layer 4 may be patterned by a known photolithography and etching technique. As etching, a dry etching or a wet etching may be used. In this patterning step, the oxide layer 3 of the SOI substrate 1 may be used as an etching stopper layer.

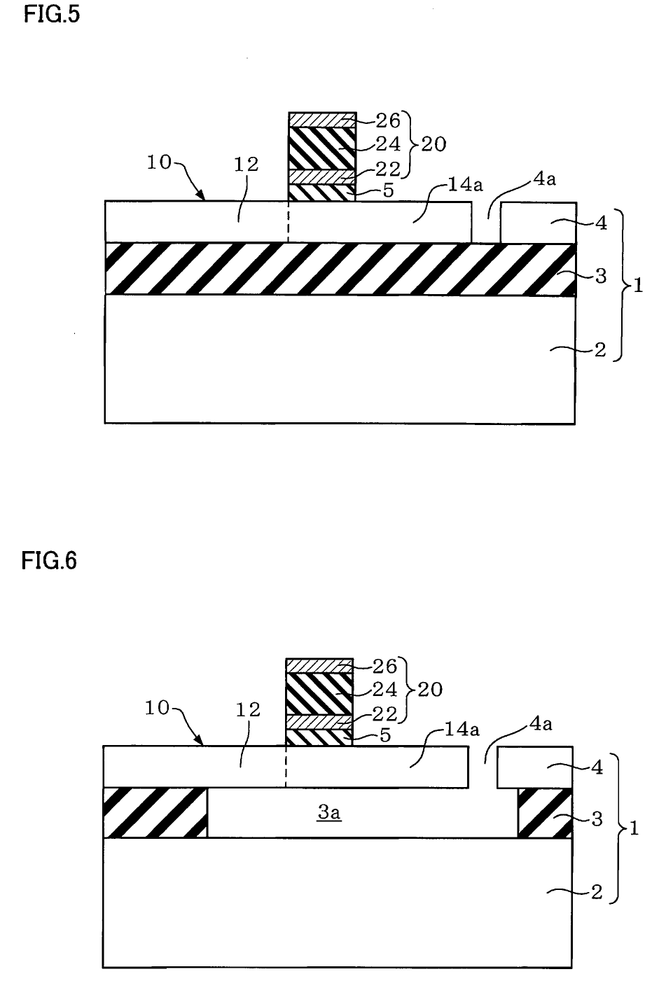

(3) As shown in FIG. 6, the opening portion 3a is formed under the vibrating portion 10 by etching the oxide layer 3 of the SOI substrate 1. The oxide layer 3 may be etched by wet etching using hydrogen fluoride as an etchant for the silicon oxide, for example. The silicon substrate 2 and the silicon layer 4 may be used as an etching stopper layer for the opening portion 3a. A mechanical constraint force on the tuning-fork type vibrating portion 10 is reduced by forming the opening 4a and the opening portion 3a, whereby the tuning-fork type vibrating portion 10 can vibrate freely.

The angular rate sensor 100 shown in FIGS. 1 to 3 can be formed by the above steps. The manufacturing method according to this embodiment allows an angular rate sensor to be easily manufactured using a known MEMS technology.

The invention is not limited to the above-described embodiments, and various modifications can be made. For example, the invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

What is claimed is:

1. An angular rate sensor comprising:
a silicon-on-insulator (SOI) substrate having a substrate, an oxide layer formed above the substrate, and a semiconductor layer formed above the oxide layer;
a tuning-fork type vibrating portion obtained by processing the semiconductor layer and the oxide layer and formed of the semiconductor layer;
a driving portion which generates flexural vibration of the vibrating portion; and
a detecting portion which detects an angular rate applied to the vibrating portion,
the vibrating portion having a supporting portion and two beam portions formed in a shape of cantilevers supported by the supporting portion;
a pair of the driving portions being formed above each of the two beam portions, each of the driving portions having a first electrode layer, a piezoelectric layer formed above the first electrode layer, and a second electrode layer formed above the piezoelectric layer; and
the detecting portion being formed above each of the two beam portions, the detecting portion being disposed between the pair of driving portions and having a first electrode layer, a piezoelectric layer formed above the first electrode layer, and a second electrode layer formed above the piezoelectric layer.

2. The angular rate sensor as defined in claim 1,
wherein the vibrating portion has a thickness of 20 micrometers or less.

3. The angular rate sensor as defined in claim 1,
wherein the vibrating portion has a length of 2 millimeters or less.

4. The angular rate sensor as defined in claim 1,
wherein the vibrating portion has a resonance frequency in a 32 kHz band.

5. The angular rate sensor as defined in claim 1,
wherein the piezoelectric layer is formed of lead zirconate titanate or a lead zirconate titanate solid solution.

6. A method of manufacturing an angular rate sensor comprising:
providing a silicon-on-insulator (SOI) substrate having a substrate, an oxide layer formed above the substrate, and a semiconductor layer formed above the oxide layer;
forming a driving portion and a detecting portion by sequentially forming a first electrode layer, a piezoelectric layer, and a second electrode layer having a specific pattern above the SOI substrate;
patterning the semiconductor layer to form a vibrating portion; and
patterning the oxide layer to form an opening portion below the vibrating portion,
the vibrating portion being formed to have a supporting portion and two beam portions formed in a shape of cantilevers supported by the supporting portion;
the driving portion being formed so that a pair of the driving portions is formed above each of the two beam portions and each of the driving portions has a first electrode layer, a piezoelectric layer formed above the first electrode layer, and a second electrode layer formed above the piezoelectric layer; and
the detecting portion being formed so that the detecting portion is disposed above each of the two beam portions and between the pair of driving portions and has a first electrode layer, a piezoelectric layer formed above the first electrode layer, and a second electrode layer formed above the piezoelectric layer.
